(19) United States
(12) Patent Application Publication
(10) Pub. No.: US 2006/0006678 A1
(43) Pub. Date: Jan. 12, 2006

(54) Door handle cover

(76) Inventor: Roy Howard Herron JR., Starr, SC (US)

Correspondence Address: Thomas A. O'Rourke;Bodner & O'Rourke, 425 Broadhollow Road, Melville, NY, 11747, US

(21) Appl. No.: 11/138,061

(22) Filed: May 26, 2005

Related U.S. Application Data
(60) Provisional application No. 60/574,856, filed on May 27, 2004.

(51) Int. Cl. E05B 3/00

(52) U.S. Cl. 292/336.3

(57) ABSTRACT

A hand hold for gripping comprising a thermoplastic elastomer and a foaming agent is described. The hand hold may also include an antimicrobial on the surface of the hand hold. The hand hold can be used on door knobs, levers and other devices where a user grip an article to operate or carry the article.

This is a conversion of U.S. Provisional Patent Application Ser. No. 60/574,856 filed May 27, 2004, the disclosures of which are incorporated herein by reference.

### FIELD OF THE INVENTION

The present invention relates to an improved grip or cover for a door handle and the like that reduces the transmission of harmful microbes from user to user as the user grabs or turns the handle to use it to open a door.

### BACKGROUND OF THE INVENTION

There are many different types of doors. The vast majority in homes and the work place are comprised of a pair of parallel sides that are joined together by generally horizontal members at the top and the bottom. The door typically has at least two hinges on one of the sides to permit the door to open.

Many doors are held in a closed position by means of a catch. This catch extends from one side of the door and enters an orifice in the door jamb. This catch is typically operated by means of a door knob or a handle. The door knob has traditionally been a generally round bulbous member on a shaft. One knob is on one side of the door and the other knob is on the other side of the door. The shaft enters the front or rear of the door and is usually designed to interact with the catch to open and close the door. As the knob or handle is turned the catch retracts into the door permitting the door to be released so that it may be opened and closed. When the knob or handle is released the catch extends into a recess in the door jamb thereby holding the door in a closed position.

More recently there have been a variety of different door knob styles that have become more widely available. Manufacturers such as Baldwin and Virginia Metalcrafters offer a wide variety of period styles. The knob can be generally round or oval in shape; the knob can also be in the form of a lever or handle that merely needs to be pushed down to open the door. The handle is preferred by many people because it permits the user to more easily open the door where the user has arthritis or difficulty in grasping a round door knob.

One of the problems with many door knobs and related surfaces that are handled by a number of people is that many scientists are coming to believe that many disease organisms can live on these surfaces and be passed from person to person just by touching a surface used by any person that is ill. As a result, there is a need for a means for reducing the presence of disease bearing microbes on surfaces such as door knobs. A number of studies have looked into these theories and addressed some of the more common diseases.

Common Cold

It is estimated that adults of all ages suffer 2-3 colds per year and pre-school children have an average of 6-12 colds per year. Turner R B. Epidemiology, pathogenesis and treatment of the common cold. Ann Allergy Asthma Immunol 1997;78:531-539. The common cold, a viral infection of the upper respiratory tract, can affect all age groups and can be caused by any of up to 200 different viruses. Rhinoviruses cause up to 40% of common colds. Coronaviruses are responsible for up to one-third of common colds. Myint S H. Human coronavirus infections. In Sidell S C, ed. The Coronaviridae. New York: Plenum Press, 1995, p389-401. Other causative viruses include parainfluenza virus, respiratory syncytial virus and adenovirus. Rhinoviruses are responsible for cases of the common cold in the general community as well as in institutional settings such as schools, day care centers and hospitals. Rhinoviruses and coronaviruses have been found to cause a greater disease burden in elderly people living at home, compared to influenza virus or respiratory syncytial virus. Nicholson K G, Kent J, Hammersley V, Cancio E. Rhinoviruses cause infections all year round, with one peak in the autumn, usually as a result of children returning to school. Colds tend to begin slowly, with the first symptom usually a sore throat, followed by sneezing, a runny nose and nasal congestion. Children may also develop a slight fever. The symptoms usually last for around seven days, but may last longer in some people. Viral shedding in nasal secretions can continue for up to 3 weeks. D'Alessio D J, Peterson J A, Dick C R, Dick E C. Transmission of experimental rhinovirus colds in volunteer married couples. J Infect Dis 1976;133:28-36.

SARS

A previously unrecognised strain of coronavirus has been detected in a high proportion of SARS patients. It is still uncertain that it is the cause of SARS, so the agent is referred to a ‘SARS associated corona virus’. Although the new coronavirus is still the leading candidate, there may be other micro-organisms involved in causing SARS. SARS generally begins with a fever greater than 100.4° F. [>38.0° C.]. Other symptoms may include headache, an overall feeling of discomfort and body aches. After 2-7 days, patients may have a dry cough and have trouble breathing. The incubation period for SARS is typically 2 to 7 days, but may be as long as 10 days.

Influenza

Influenza, or ‘flu’, affects all age groups, with outbreaks tending to occur in the winter and early spring. There are three types of influenza viruses: A, B and C. Type A constantly changes with new strains appearing regularly and is usually responsible for the large epidemics. Influenza A is usually a more severe infection than influenza B, which causes smaller, more localised outbreaks. Type C is less common.

Influenza virus can be shed before symptoms appear and up to 7 days after onset of illness, therefore people are potentially infectious before symptoms develop as well as after symptoms appear. The young are at risk because they have not usually developed immunity to the virus. The elderly and persons with underlying health problems are at increased risk from complications. Common symptoms of the flu include sudden onset of fever, headache, chills, fatigue, muscle aches and pains, runny nose, sore throat and dry cough. The symptoms quickly become more severe than those of a common cold.

Other Viral Infections

A variety of other respiratory viruses can cause ‘flu-like’ symptoms, sometimes with infection of the lower respiratory tract. Respiratory Syncytial Virus (RSV) can infect the same person several times during a lifetime. It causes more severe illnesses (e.g. bronchiolitis, pneumonia) in children, but only a ‘common cold-like infections’ in adults. It can also produce a flu-like illness indistinguishable from influenza. RSV affects about 90% of children by the age of 2 years. Simoes EAF. Respiratory syncytial virus. Lancet 1999;354:847-852. It is often carried home by school children and passed onto their siblings within the home. The virus can spread rapidly in day-care centers, hospitals and nursing homes. Infections occur mainly in winter to early spring and are associated with high incidence of secondary pneumonia and death in the elderly. Nicholson K G. Impact of influenza and respiratory syncytial virus on mortality in England and Wales from January, 1975 to December, 1990. Epidemiol Infect 1996;116:51-63.

Human metapneumovirus (hMPV) is a closely related to RSV. It was only recently identified in 2001. It is associated with mild respiratory infections as well as severe bronchiolitis and pneumonia. hMPV infections are thought to occur mostly during winter. The number of people that suffer from hMPV each year is still to be determined. Infection occurs in infants and young children but hMPV has been found in older children and adults suggesting re-infection may occur later on in life. Parainfluenza viruses (PIV) are a major cause of acute respiratory tract infections. They may cause lower respiratory illnesses (bronchitis, pneumonia) in young children. In older children and adults parainfluenza virus causes upper respiratory illnesses (e.g. common colds) which are usually only mild. Parainfluenza peaks in the late autumn to early winter.

Most lower respiratory tract infections due to adenoviruses are mild and indistinguishable from other viral respiratory infections. Adenoviruses are a less frequent cause of LRTI in children than RSV or PIV, but can cause epidemics of severe LRTI in young children. Adenoviruses are implicated in 5-11% of upper respiratory tract infections, and are also implicated in cases of pharyngitis, pneumonia, bronchiolitis and croup in children. Cherry J D. Adenoviruses. In Textbook of Pediatric Infectious Diseases Vol 2. Ed Feigin R D and Cherry J D. pp1666-84. Philadelphia: W B Saunders, 1998.

The routes of transmission of common colds are still under debate. The commonly held belief is that colds are spread by particles of infected mucus generated by coughs and sneezes. When someone is infected they can shed millions of virus particles in the mucus they produce. However, increasingly there is evidence that infection occurs not only by inhalation of mucous droplets but also e.g via the hands. This can occur when fingers become contaminated by contact with the infected nose, or when surfaces such as handkerchiefs and tissues, tap and door handles or telephones become contaminated by droplets of infected mucous shed from the nose. Goldmann D. Transmission of viral respiratory infections in the home. Paediatr Infect Dis J 2000;19:S97-S102. The virus is passed onto another person either by handshaking or when contaminated surfaces are touched by that person. It is not known which transmission routes are the most important. Common cold viruses infect the nose lining and are found in very high levels in the mucus. Coughs and sneezes produce an aerosol containing virus-laden mucus particles. The smaller particles may remain suspended in the air for hours and persist for some time. Although it is believed that someone who is coughing and sneezing spreads the common cold very easily, it is very difficult to demonstrate this means of transmission in the laboratory. Some experiments have tried to demonstrate that colds can be spread via aerosol transmission. D'Alessio D J, Meschievitz C K, Peterson J A, Dick C R, Dick E C. Short-duration exposure and the transmission of rhinoviral colds. J Infect Dis 1984; 150:189-194, Dick E C, Jennings L C, Mink K A, Wartgow C D, Inhom S L. Aerosol transmission of rhinovirus colds. J Infect Dis 1987;156:442-448. Volunteers with colds played cards with healthy volunteers for twelve hours whilst prevented from touching their nose or eyes by means of a large neck collar and arm brace. Just over half the healthy volunteers developed colds and the experimenters concluded that infection could only have occurred via aerosol transmission. The hypothesis that colds are spread via large particles of mucus which settle rapidly onto surfaces is consistent with evidence suggesting that colds are not particularly contagious. In this situation infection occurs only at close range when someone is sprayed with droplets of mucus that enter the eye or are inhaled via the nose. Although there is evidence for spread of common colds the airborne route, there is little evidence that coughs and sneezes actually produce an aerosol of infected nasal mucus. In one study, volunteers with colds were housed in a room and the air sampled for virus; although 82% of the air sampled no virus was detected. Hendley J O and Gwaltney J M, Jr. Mechanisms of transmission of rhinovirus infections, Epidemiol Rev 1988; 10:242-258. When volunteers were asked to cough or sneeze directly onto a surface designed for virus detection, virus was recovered from only 2 in 25 volunteers. Coughs and sneezes tend to spray saliva from the pool at the front of the mouth rather than droplets of mucus from the nose. Saliva contains little or no cold virus and thus aerosolised saliva is unlikely to spread infection. Colds are not caught by kissing as cold viruses do not infect the mouth and saliva contains very little virus. When volunteers infected with common cold virus kissed ‘coldfree’ volunteers for up to 1.5 minutes, only one case of cross infection occurred in 16 trials.

By contrast infected nasal mucus readily contaminates the hands when they are used to wipe the nose or block a cough or sneeze. Infected mucus may then contaminate commonly touched surfaces such as desks and door handles. The chain of infection is completed when an uninfected person touches the mucus-contaminated surface and contaminates their hands. They then infect themselves by touching their own nose or eye. The eye acts as an entrance for infection as virus enters the tear fluid, which drains down a duct into the nose. In a study where asthmatic children were trained not to touch their nose and eyes so frequently, a reduction in self-inoculatory behaviour was observed which was associated with 47% reduction in laboratory diagnosed cold infections and 45% reduction in cold-associated asthma attacks. Corley D L, Gevirtz R, Nideffer R, Cummins L. Prevention of postinfectious asthma in children by reducing self-inoculatory behaviour. J Pediatr Psychol 1987;12:519-531.

Indications are that cold viruses deposited on surfaces can remain viable in large numbers, for several hours. By contrast with bacteria the ‘infectious dose’ i.e. the number of viral particles required to cause infection may be very small. For rhinovirus the infective dose may be less than ten. It has been shown that infectious virus can be recovered from naturally contaminated objects in the surroundings of persons with rhinovirus colds and that clean hands can readily pick up the virus by touching or handling such objects. Rhinoviruses can survive for several hours on the hands, and self-inoculation by rubbing of the nose or eye with virus-contaminated hands can lead to infection in susceptible hosts. After handling contaminated coffee cup handles, 50% of subjects developed an infection. The importance of contaminated fingers in spreading the common cold was demonstrated amongst families. Mothers who regularly disinfected their hands with a dilute iodine solution had a slightly lower rate of infection than mothers using an inactive hand wash. Gwaltney J M, Hendley J O. Transmission of experimental rhinovirus infection by contaminated surfaces. Am J Epidemiol 1982;116:828-833, Sattar S A, Jacobsen H,. Springthorpe S, Cusack T, Rubino J. Chemical disinfection to interrupt the transfer of Rhinovirus type 14 from environmental surfaces to hands. Appl Environ Microbiol 1993;59:1579-1585, Sizun J, Yu M W N, Talbot P J. Survival of human coronaviruses 229E and OC43 in suspension and after drying on surfaces: a possible source of hospital-acquired infections. J Hosp Infect 2000;46:55-60.

SARS Transmission

Based on current evidence, close contact with an infected person poses the highest risk of crossinfection from one person to another. Infectious mucous droplets are produced by sneezing, coughing etc. These droplets may contaminate the hands or can settle on nearby objects or surfaces. It is thought the virus may remain infective for up to 24 hours on dry surfaces. Other coronaviruses studied to date have not remained viable beyond 3-4 hours. Sizun J, Yu M W N, Talbot P J. Survival of human coronaviruses 229E and OC43 in suspension and after drying on surfaces: a possible source of hospital-acquired infections. J Hosp Infect 2000;46:55-60.

As with the common cold, it is thought that the virus can be spread by inhalation of infected droplets, or by people touching other people, or objects and surfaces that are contaminated with infectious droplets. Infection then occurs by transferring the virus from the hands to the eye(s), nose, or mouth. It is also possible that SARS is spread more broadly through the air or by other ways that are currently not known. SARS, like colds, appears to be less infectious than influenza. Indications are that spread from fecal matter infected with the virus was the cause of the majority of the 300+ SARS cases in the apartment block outbreak in Hong Kong. An official investigation concluded that leaking sewage pipes and inadequate seals on U-bends were major contributors to the outbreak and that airborne particles carried the virus throughout the complex.

Influenza Spread

Studies have shown that influenza virus is also shed in large numbers from an infected person. Influenza can be spread from person to person by aerosol transmission due to sneezing and coughing. Like colds it can also be spread via the hands by contact with objects that an infected person has contaminated with infectious nose and throat secretions although there is less supporting evidence for this mode of spread than for colds. Influenza viruses can survive on surfaces such as stainless steel and plastic for 24-48 hours (Bean B, Moore B M, Peterson L R, Gerding D N, Balfour H H. Survival of influenza viruses on environmental surfaces. J Infect Dis 1982;146:47-51) and for up to 12 hours on soft surfaces such as cloth, paper and tissues. Influenza A virus was transferred from contaminated stainless steel surfaces to hands for 24 hours after a surface was inoculated. It easily spreads in institutional settings and crowded places, for example, an outbreak of influenza virus in a nursing home may have been mediated by staff either via contaminated hands. Morens D M, Rash V M. Lessons from a nursing home outbreak of influenza A. Infect Cont Hosp Epidemiol 1995;16:275-80.

Other Respiratory Viruses

Human Parainfluenza Virus (HPIV) and Respiratory Syncytial Virus (RSV) may survive sufficiently long enough in the environment to allow transfer of infectious virus to hands that contact contaminated surfaces. Hall C B, Douglas R, Geiman J M. Possible transmission by fomites of respiratory syncytial virus. J Infect Dis 1980; 141:98-102. The transfer of HPIV from stainless steel discs to clean fingers supports a role for surfaces in the viral contamination of hands. Ansari S A, Springthorpe V S, Sattar S A, Rivard S, Rahman M. Potential role of hands in the spread of respiratory viral infections—studies with human parainfluenza virus 3 and rhinovirus 14. J Clin Microbiol 1991;29:2115-2119.

HPIV was recovered from hard surfaces up to 10 hours later when the surface remained moist. The virus persisted on hands for a minimum of 1 hour and on dry surfaces for up to 2 hours. 25 Parainfluenza virus may have an infective dose via the nasal route of less than 80 particles. Smith C B, Purcell R H, Bellanti J A, Chanock R M. Protective effect of antibody to parainfluenza type 1 virus. New Engl J Med 1966;275:1145-1149.

Transmission of respiratory adenoviruses is by aerosolized droplets reaching the conjunctiva, nose or throat or by the faecal-oral route. Close contact appears to be necessary for infection to spread from one person to another, and thus illness spreads rapidly in closed environments.

All of the above demonstrate that the contraction with bacterial diseases may be significantly decreased by eliminating or substantially reducing the amount of harmful microbes on the surfaces of items of public use. This invention offers fast, non-toxic, efficient and convenient way to equip various utilitarian articles such as door knobs, toilet or urinal handle with anti-bacterial cover.

### OBJECTS OF THE INVENTION

It is an object of the invention to provide a cover for handles and the like that will protect the user from infection.

It is another object of the invention to provide a grip for door handles and the like that will provide a comfortable grip.

It is a further object of the invention to provide an improved grip for round, bulbous door handles.

It is a still further object of the invention to provide an improved cover for a lever type handle.

Another object of the present invention is to solve the problem of possible contraction of microbe-originated infectious diseases through providing flexible non-toxic plastics that have antibacterial effect.

A further object of the invention is to provide a device for protecting individuals using various kinds of public use items like a door handles from contracting with harmful microbes.

It is an object of the invention to provide a unique door knob cover with a unique gripping surface.

It is also an object of the invention to provide a unique door know or lever with a surface that facilitates turning of the knob or lever with minimal contact and effort.

It is a still further object of the invention to provide a stretchable cover for door knobs and levers that accomodates multiple door knob styles and sizes.

It is a further object of the invention to provide a door knob and lever cover that slides on easily without requiring the use of tools.

It is another object of the invention to provide a grip for a handle or lever that is comfortable to the touch.

It is still another object of the invention to provide a cover or grip for a handle that insulates a metal knob or lever from extreme temperature.

It is a still further object of the invention to provide a cover or grip that can be used with faucet handles and other types of handles and levers.

### SUMMARY OF THE INVENTION

The present invention relates to a cap or cover that may slip over a door knob or door handle. The present invention may also be used on handles or levers for faucets. Other uses for the invention include covers for bicycle handles, handles for supermarket carts, steering wheels, cabinet handles, handles for oars, ax handles, joystick handles, tool handles, on playground equipment such as slides, hand grips, swing chains and the like. More particularly, the present invention may be used as a protective covering that may go over any hand hold which is susceptible to use by a number of people. In an alternative embodiment, the present invention may be in the form of a door knob that can be positioned over the door knob and at least a portion of the exposed shaft. In another embodiment, the cover can be in the form of a sheet that is wrapped around the knob and held in place by a suitable means. The cover is preferably made of a soft plastic that is pleasant to the touch and easy to install and has an antimicrobial material embedded in the plastic. This microbial material is present on the surface of the plastic typically due to migration of the antimicrobial material to the surface. Alternatively, the antimicrobial material can be a coating on the exterior surface of the grip. The article of the present invention can take any number of different shapes depending on the application. A preferred shape is a tubular shape having a sidewall being open at each end and hollow along its length. In another embodiment, the tubular member may have a slit on the side to facilitate positioning the article over a hand hold. In a still further embodiment, the article can be spherical in shape with an opening to the center which permits the article to be positioned over a door handle.

### BRIEF DESCRIPTION OF THE DRAWINGS

FIG. 1 is a perspective view of a representative door knob.

FIG. 2 is a side view of a door knob cover of the present invention.

FIG. 3 is an alternative embodiment of the cover of the present invention positioned to be placed over a door knob.

FIG. 4 is a side view of the cover of FIG. 3.

FIG. 5 is a perspective view of a second alternative embodiment of the cover of the present invention.

FIG. 6 is another embodiment of the cover of the present invention.

FIG. 7 is a view of the cover of FIG. 7 over a handle on a door.

FIG. 8 is an example of a grip that is useful on a lever style handle or for other applications where a tubular hand hold cover is required.

FIG. 9 is an alternative embodiment of the grip FIG. 8 for use on a traditional bulbous handle.

FIG. 10 is an alternate embodiment of the grip of FIG. 9 where the material used to make the grip is a clear plastic material.

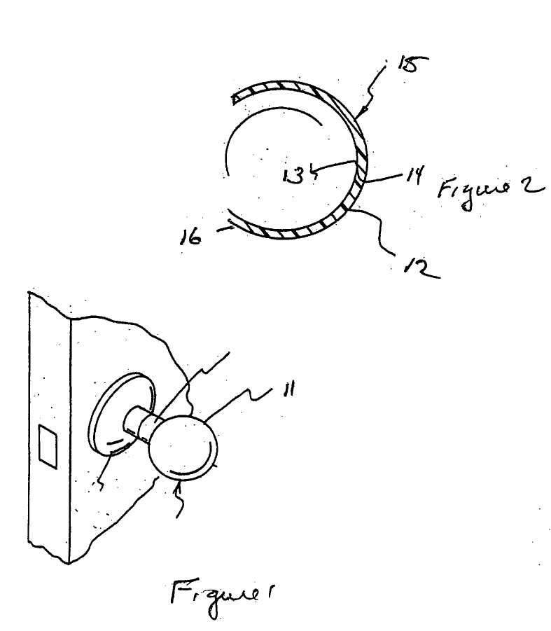

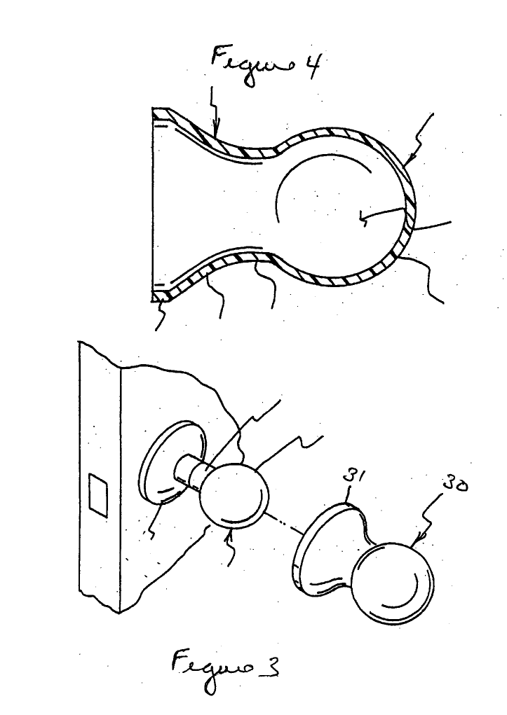

### BRIEF DESCRIPTION OF THE INVENTION

The cover of the present invention can be many different shapes, depending on the handle or door knob or other article that is being covered. For example, where the knob is a traditional one 11, having a stem and a generally spherical or ovoid shape, the cover 12 has a generally round shape. There is an inside surface 13 and an outside surface 14. The inside surface will preferably snugly conform to the shape of the handle. The interior surface of the cover is preferably a non-slip material having a generally high coefficient of friction with respect to the composition of the handle. The cover has a front face 15 that covers the knob and a rear face 16 that is provided with an orifice to permit the cover to be positioned over the knob. The cover is preferably made from a plastic material that has the ability to stretch when pulled to more easily fit over the knob.

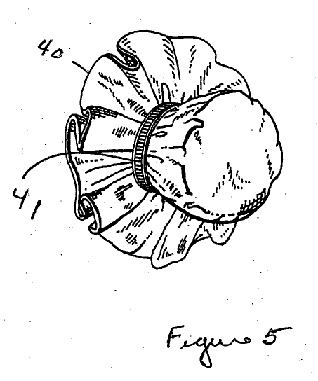

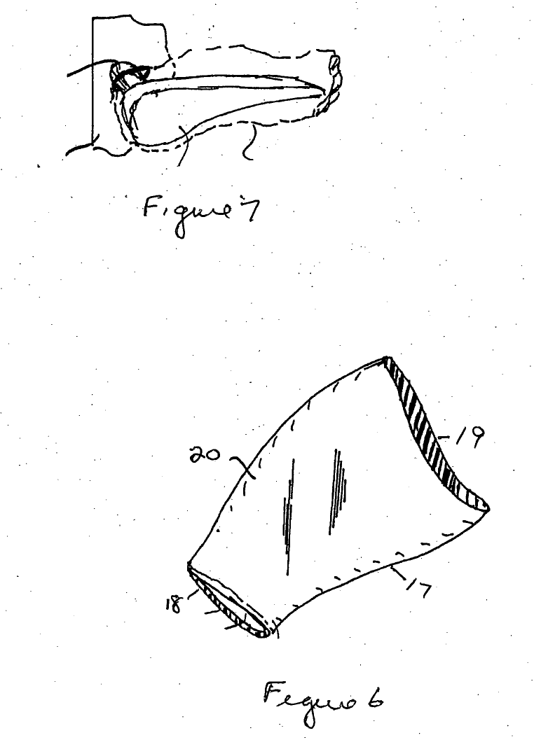

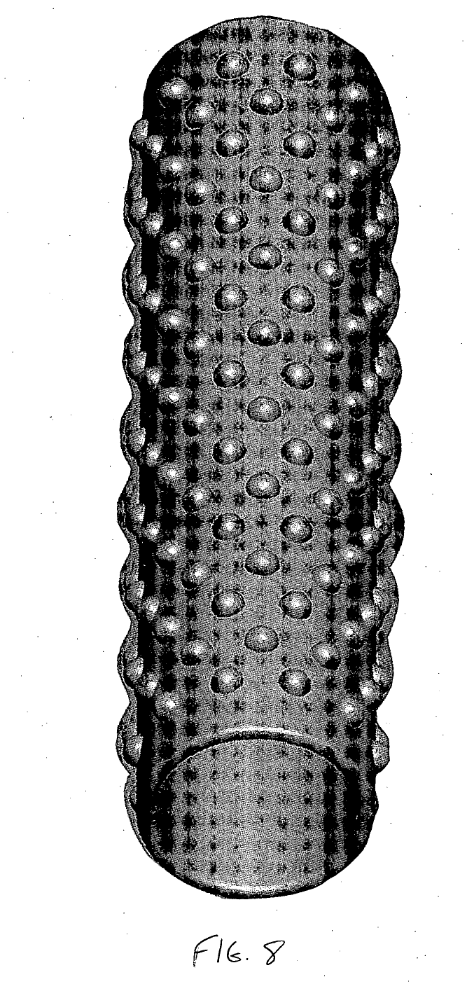

As seen in FIG. 3 the cover 30 may be generally in the shape of a door knob and have a skirt 31 that receives the knob. As seen in FIG. 5 the cover may be in the form of a sheet 40 that may be wrapped around the knob and secured by means of a string or elastic 41.

In another embodiment, the cover may be in the form of a sleeve 17. The sleeve has a first end 18 and a second end 19. The two ends are joined together by means of a side wall 20. One end 18 of the sleeve is open and the other is preferably closed but could be opened. The open end slips over the handle starting at the end of the handle. The sleeve can be any length and any diameter. Also, the shape of the cross-section can vary as well. While a round cross-section is shown, the cross section could be square, triangular, rectangular and combinations thereof. Preferably the sleeve 17 or cover 30 is flexible and has some stretchability to provide a snug fit.

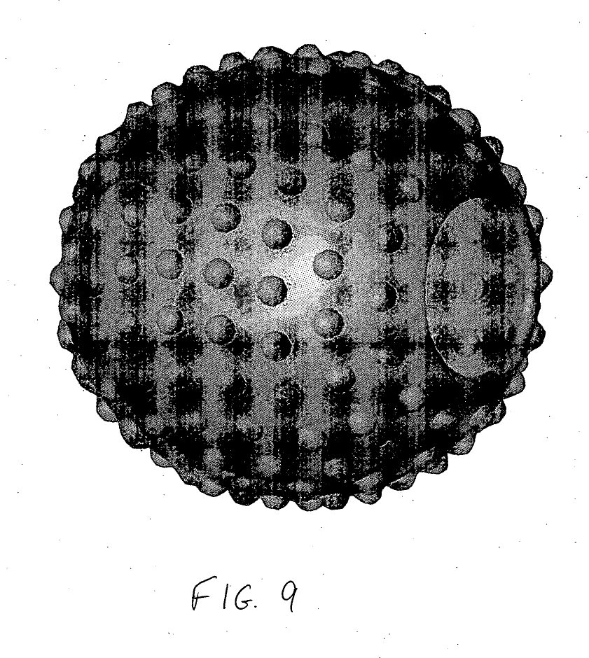

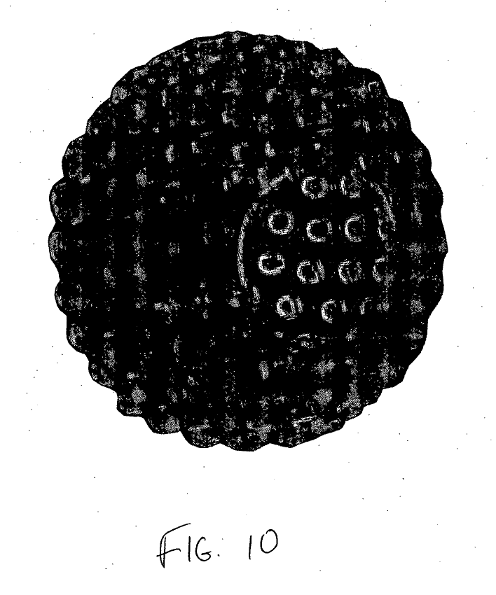

The plastic material preferably has an antimicrobial material on the surface of the cover. This antimicrobial material may be a coating. Alternatively, it can migrate to the surface. The coating can be applied by any suitable manner such as by spraying various types of deposition such as vapor deposition, etc. The antimicrobial material is preferably added to a thermoplastic material as it is being extruded on cast or blow molded or injection molded into the desired shap for the knob. The antimicrobial material typically migrates to the outer surface of the plastic where it will prevent microbes from living and coming into contact with users of the door knob. Besides the purposes of disinfection, the thermoplastic material has good temperature and chemical insulation providing at the same time good finishing and comfortable touch. As depicted in FIG. 8 and FIG. 9 to further increase the utility of the handle cover, the surface of the cover may be covered with bubble-like extensions that may provide better grip which may reduce possible skidding of fingers or the amount of effort that may be applied to the handle in order to rotate it. FIG. 10 illustrates the application of the invention to the door knob which is shown to have bubble-like multiple extensions on its gripping portion. FIG. 10 also shows a translucent grip which could also be opaque or translucent. The grip may also be provided with one or more folds or indentations in the outer surface to increase the ability of the user to grip the handle.

The thermoplastic material may be any suitable material the can be formed into the desired shape of a door knob or door handle. The plastic material is preferably one that permits migration of the antimicrobial to the surface of the knob or handle. The preferred composition also permits the antimicrobial to be coated onto the surface. A preferred thermoplastic material is a TPE or thermoplastic elastomer. Thermoplastic Elastomers (TPE's) are a class of engineering materials combining the look, feel and elasticity of conventional thermoset rubber with the processing efficiency of plastics. Because TPEs are thermoplastics, their melt-processability makes them very suitable for high-volume injection molding and extrusion. They can also be reclaimed and recycled. As elastomers, TPEs exhibit true elasticity. Most range of grades encompasses rubberlike properties and offer a wide range of durometers, low compression set, and high elongation. TPE's as used herein include, but are not limited to, any one or combination of the following: thermoplastic polyurethane elastomers (i.e., TPUs), polyolefin-based thermoplastic elastomers (i.e., TPOs), thermoplastic elastomers based on dynamically vulcanized elastomer-thermoplastic blends (i.e. TPVs), thermoplastic polyether ester elastomers, thermoplastic elastomers based on halogen-containing polyolefins, thermoplastic elastomers based on polyamides, styrene based thermoplastic elastomers, and ethylene-.alpha.-olefin copolymer thermoplastic elastomers. A preferred TPE is one of the “Sub 00” TPE's on the market. These are TPE's that are about the hardness of a plastic fishing worm. The preferred composition is a foamed material. The foamed material is formed by extruding a soft TPE material to which a foaming agent has been is added through a die. The foaming process takes place immediately as the material exits the die. Suitable foaming agents include a physical or chemical blowing agent. Foaming agent is described in U.S. Pat. No. 6,548,562 to Brzoskowski, the disclosures of which are incorporated herein by reference. Other additives may be included in the composition including but not limited to organic and/or inorganic pigments, heat stabilizers, antioxidants, UV absorbers, light stabilizers, flame retardants, and/or anti-blocking agent.

The antimicrobial material is preferably an antimicrobial agent (i.e., an additive that is capable of inhibiting the growth of viruses, bacteria, fungi, and other microbes) and can be incorporated onto or into the thermoplastic composition to disinfect a user's skin and/or to inhibit the further spread of certain microbes. Typically, an antimicrobial agent utilized in the present invention is biocompatible. The antimicrobial agent can be soluble in the oil or water phases, or can reside in either phase as a suspension. For example, some suitable antimicrobial agents that can be used in the present invention include, but are not limited to, chlorohexidine gluconate; parachlorometaxylenol (PCMX); benzylthoneium chloride; chitosan, such as chitosan pyrrolidone carboxylate; 2,4,4′-trichloro-2′-hydroxydiphenyl ether (triclosan), etc. Other suitable antimicrobial agents are described in U.S. Pat. No. 5,871,763 to Luu, et al., U.S. Pat. No. 5,334,388 to Hoang, et al., and U.S. Pat. No. 5,686,089 to Mitra, et al., which are incorporated herein in their entirety by reference thereto for all purposes.

Nonlimiting examples of other suitable antibacterial agents include combinations of amber and musk materials to mask malodor (WO 98/56337); antibacteriocidal compositions containing 5-chlorosalicylanilide (WO 01/60157); antimicrobial compositions containing aminoalkyl silicone, improved surface residuality (WO 96/19194); antimicrobial polypeptides (WO 96/28468); antimicrobial compositions containing AE/AO compounds and phenols (WO 98/01524); antimicrobial activity of alcohols (WO 97/21795); betaine compositions with good antimicrobial activity (WO 97/43368 and WO 97/43369); High pH non-ionic solutions as antimicrobial agents (WO 01/44430); Capsule for controlled release of textile treatment agents (DE 19 931 399); Composition containing benzylakylammonium, zinc PTO, climbazole (WO 98/01527); alkyldimethylammonium and alcohol ehtoxylates as effective antibacterial compositions (GB 2 322552); cyclohexyl esters for odor neutralization (WO 01/43784); alkoxy disulphide antimicrobial agents (EP 1 008 296); bromofuranones as antibacterial agents (WO 01/43739) and mixtures thereof. Microban and Alphasan and other suitable antimicrobials may also be used if desired.

One type of antimicrobial that may be used is silver. Silver has known antimicrobial properties. One form of silver that may be used is a silver in a matrix which is in the form of a silver complex until exposure to skin or fluid which activates the release of antimicrobial silver. The amount of silver released is controlled by a suppression mechanism that causes the reformation of the stabilized silver complex form. These mechanisms regulate sustained release and protect against photoconversion of ionic silver from light and irradiation. Ionic silver released from the matrix migrates into the surrounding substrate where it may inactivate or kill microorganisms. The rate of silver release is controlled to sustain an antimicrobial level of activity throughout the typical life of the handle. Silver particles in the sub-50 nanometer range exhibit increased efficacy in fighting a wide range of bacteria and fungi and are, therefore, preferred. The silver crystalline nanoparticles are produced in a carbon matrix to minimize particle agglomeration, resulting in discrete silver particles.

Another material that can be used for the articles of the present invention is a compound, termed Elastoguard-HNBR, a high temperature formulation that incorporates a silver-based biocide, which permeates parts molded from the material to provide protection against bacteria. The Elastoguard anti-microbial additive is a silver-sodium-zirconium phosphate ion-exchange resin. Once the molded part has been vulcanized, the additive is encapsulated in the rubber matrix where it permeates the entire part to give skin-to-core protection. Bacteria absorb the ions released by the additive, which break down their cell walls and destroy them. The antimicrobial compounds used can also include traditional antibiotics as well as organic antimicrobials such as triclosan and benzalkonium chloride and inorganic compounds such as heavy metals. The antimicrobial compound can be coated onto solid surfaces and use ion exchange to release active silver particles. The compound material may be a zeolite containing 2.5% (with/with) silver (Ag) and 14% Zinc (Zn) ions within alumino-silicate matrices. Products can be coated with an epoxy containing the silver-zeolite additive. In one approach, a wet-process method the epoxy can be dissolved in solvent, applied to the handles, and heated to remove the solvent. The second is a powder-coating method which would involve applying an electrical charge to the epoxy-zeolite mixture in a dry form. The electrical charge can cause the powder to adhere to the surface of the handle which was then heated to a temperature below the melting point to the material in the handle so that the powder melts, flows and cures to form generally a continuous film. The antimicrobial/antifungal additives can also be inorganic compounds using such metals as: copper, zinc, tin, and silver. The zeolite can be dispersed in a polyethylene (PE), PET, or polybutylene terephthalate (PBT) carrier, but could be added directly to a melt of a thermoplastic without an intermediate carrier. The total antimicrobial additives range from about 0.005 to 20% by weight of thermoplastic, preferably about 0.1% to about 15% by weight of thermoplastic. More preferably the antimicrobial additive can range from about 0.175% to about 10% by weight thermoplastic and most preferably 0.2% (0.002) to 6.0% (0.06) by weight of thermoplastic depending on performance requirements. The anti-microbial additives are held in the handle and are prevented from washing off over time and remain effective.

What is claimed is:

1. A hand hold for gripping comprising a thermoplastic elastomer and a foaming agent.

2. The hand hold according to claim 1 further comprising an antimicrobial present on the surface of a hand hold made from said thermoplastic elastomer and foaming agent.

3. The hand hold according to claim 2 wherein said antimicrobial mixed with said thermoplastic elastomer when said elastomer is in a molten state and said antimicrobial migrates to an exterior surface of said thermoplastic.

4. The hand hold according to claim 2 wherein said antimicrobial is a coating on an exterior surface of said thermoplastic.

5. The hand hold according to claim 2 wherein the thermoplastic foaming agent and antimicrobial are in the form of a cover for a door knob.

6. The hand hold according to claim 5 wherein the door knob is generally spherical in shape and having an opening in an exterior surface for receiving a door knob.

7. The hand hold according to claim 6 wherein said hand hold has a plurality of protrusions on its exterior surface to facilitate gripping the hand hold.

8. The hand hold according to claim 2 wherein the thermoplastic foaming agent and antimicrobial are in the form of a hollow sleeve having an interior surface and an exterior surface and a pair of ends being joined by a body.

9. The hand hold according to claim 8 wherein said sleeve has a slit through the body from one end of said sleeve to the opposite end of said sleeve.

10. The hand hold according to claim 8 wherein said hand hold has a plurality of protrusions on its exterior surface to facilitate gripping the hand hold.

11. The hand hold according to claim 6 wherein said antimicrobial is from 0.005% by weight to 20% by weight of the thermoplastic.

12. The hand hold according to claim 11 wherein said antimicrobial is from 0.01% by weight to 15% by weight of the thermoplastic.

13. The hand hold according to claim 12 wherein said antimicrobial is from 0.1% by weight to 10% by weight of the thermoplastic.

14. The hand hold according to claim 13 wherein said antimicrobial is from 0.2% by weight to 6% by weight of the thermoplastic.

15. The hand hold according to claim 8 wherein said antimicrobial is from 0.005% by weight to 20% by weight of the thermoplastic.

16. The hand hold according to claim 15 wherein said antimicrobial is from 0.01% by weight to 15% by weight of the thermoplastic.

17. The hand hold according to claim 16 wherein said antimicrobial is from 0.1% by weight to 10% by weight of the thermoplastic.

18. The hand hold according to claim 17 wherein said antimicrobial is from 0.2% by weight to 6% by weight of the thermoplastic.

19. The hand hold according to claim 8 wherein one of said ends is closed.
